(19) United States
(12) Patent Application Publication
(10) Pub. No.: US 2026/0295827 A1
(43) Pub. Date: Oct. 1, 2026

(54) ROBOT CONTROL DEVICE

(71) Applicant: FANUC CORPORATION, Minamitsuru-gun, Yamanashi (JP)

(72) Inventor: Yuusuke KURIHARA, Yamanashi (JP)

(21) Appl. No.: 19/479,611

(22) PCT Filed: May 12, 2023
(86) PCT No.: PCT/JP2023/017955

§ 371 Date: Oct. 28, 2025

(51) Int. Cl. B25J 9/16

(52) U.S. Cl. CPC B25J 9/1651; B25J 9/163

(57) ABSTRACT

The present invention provides a technique that, in accordance with a robot path at the time when teaching was performed, can reproduce the speed at the time when the teaching was performed, and can easily change position and speed afterwards. Provided is a robot control device 1 comprising at least one storage device 11, and at least one processor 17. The storage device 11 stores position information of a robot 2, time information at the time when the position information was stored, and an operation program for the robot 2. The processor 17 generates an operation instruction including an operation speed of the robot 2, on the basis of the position information and the time information, and generates an operation program for the robot 2 on the basis of the generated operation instruction.

### TECHNICAL FIELD

The present disclosure relates to a robot control device.

### BACKGROUND ART

Conventionally, there has been known a technique of generating an operation program for a robot using a direct teaching function that allows an operator to directly operate the robot, for example, by holding a robot arm by hand (see, e.g., Patent Document 1). In order to store a robot path when the robot is moved by the direct teaching, the position of the robot needs to be stored in certain cycles or at every certain distance. In order to reproduce the stored robot path, an operation command needs to be generated for each stored teaching point.

### CITATION LIST

### Patent Document

Patent Document 1: Japanese Unexamined Patent Application, Publication No. 2023-38776

### DISCLOSURE OF THE INVENTION

### Problems to be Solved by the Invention

In some cases, fast and slow operation of the robot taught by the operator in the direct teaching is reproduced. For such reproduction, a technique of moving the robot at a speed at the time of the teaching according to the stored robot path is demanded.

After the teaching, the position and speed of the robot need to be finely adjusted in some cases. For such adjustment, a technique of easily changing these parameters afterward is demanded.

The present disclosure has been made in view of the above-described problems, and is intended to provide a technique capable of reproducing a speed at the time of teaching according to a robot path at the time of the teaching and easily changing a position and a speed afterward.

### Means for Solving the Problems

The present disclosure is a robot control device for controlling a robot, which includes at least one storage device and at least one processor, in which the storage device stores position information on the robot, time information at the time of storage of the position information, and an operation program for the robot, and the processor generates an operation command including the operation speed of the robot based on the position information and the time information, and generates the operation program for the robot based on the generated operation command.

Moreover, the present disclosure is a robot control device for controlling a robot, which includes at least one storage device and at least one processor, in which the storage device stores position information on the robot, time information at the time of storage of the position information, and an operation program for the robot, and the processor generates an operation command including the operation speed of the robot based on the position information and the time information, and writes the generated operation command into the operation program stored in the storage device.

### BRIEF DESCRIPTION OF THE DRAWINGS

FIG. 1 is a view showing a robot system including a robot control device according to a first embodiment;

FIG. 2 is a functional block diagram of the robot control device according to the first embodiment;

FIG. 3 is a diagram for describing a first example of processing executed by the robot control device according to the first embodiment at the time of direct teaching;

FIG. 4 is a flowchart showing the steps of the first example of the processing executed by the robot control device according to the first embodiment at the time of the direct teaching;

FIG. 5 is a diagram for describing a second example of the processing executed by the robot control device according to the first embodiment at the time of the direct teaching;

FIG. 6 is a flowchart showing the steps of the second example of the processing executed by the robot control device according to the first embodiment at the time of the direct teaching; and

FIG. 7 is a functional block diagram of a robot control device according to a second embodiment.

### PREFERRED MODE FOR CARRYING OUT THE INVENTION

Hereinafter, embodiments of the present disclosure will be described in detail with reference to the drawings. Note that in the description of a second embodiment and embodiments subsequent thereto, components common to those of a first embodiment are denoted by the same reference numerals and the description thereof will be omitted as necessary.

### First Embodiment

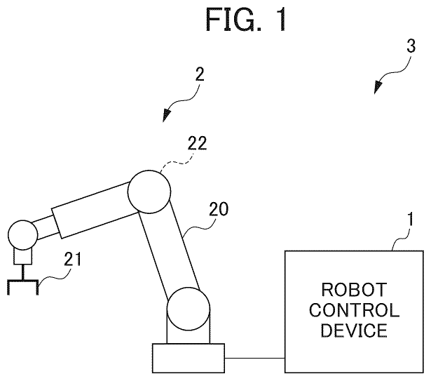

FIG. 1 is a view showing a robot system 3 including a robot control device 1 according to the first embodiment. As shown in FIG. 1, the robot system 3 of the present embodiment includes the robot control device 1 and a robot 2. The robot system 3 according to the present embodiment has a direct teaching function capable of directly operating the robot 2 with an operator holding a robot arm 20 with one's hand, or the like.

The robot control device 1 is a computer that controls operation of the robot 2 based on an operation program for machining a workpiece (not shown) which is an object to be machined. The robot control device 1 can reproduce a movement speed at the time of teaching according to a robot path taught by the direct teaching function, and generates the operation program for the robot 2, which can easily change a position or a speed afterward. Details of the robot control device 1 will be described later.

The robot 2 is, for example, a six-axis vertical articulated robot, and includes a hand 21 at the tip end of the robot arm 20 of the robot 2. The robot 2 is controlled by the robot control device 1 not only to handle the workpiece as the target object, but also to execute various machining processes on the workpiece using various machining tools.

Further, the robot 2 includes a plurality of state detectors 22 that detects the position and orientation of the robot 2. The state detector 22 includes a servomotor provided for each drive shaft of the robot arm 20, a position (rotation angle) detector attached to each servomotor, such as an encoder, and the like. Note that in FIG. 1, only the state detector 22 for one drive shaft is shown for the sake of convenience. At the time of the direct teaching, the plurality of state detectors 22 detects a torque, the speed, or the position, so that the position and orientation of the robot 2 can be acquired and operation path information indicating robot path and speed and a series of operation of the robot 2 including stop thereof can be acquired.

Alternatively, an operation unit (not shown) such as an operation handle may be provided at a wrist of the robot 2, and a force sensor that detects a force applied to the operation unit by the operator may be built in, so that the position and orientation of the robot 2 can be acquired according to the magnitude and direction of the force detected by the force sensor.

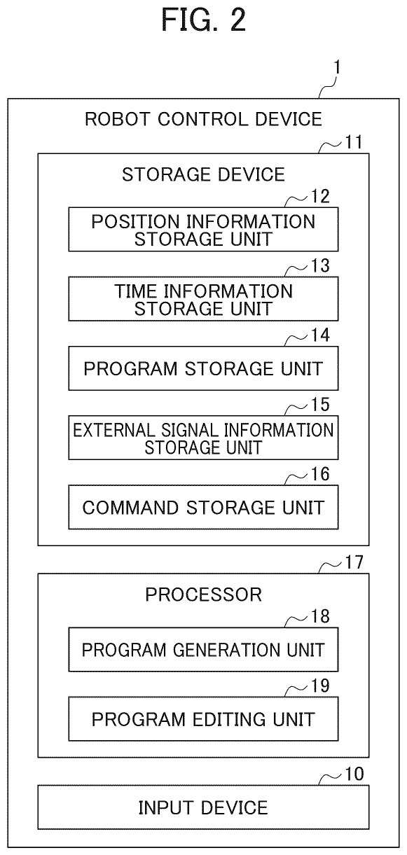

Next, robot control device 1 will be described in detail. FIG. 2 is a functional block diagram of the robot control device 1 according to the present embodiment. The robot control device 1 of the present embodiment is configured using a computer including a memory such as a read only memory (ROM) or a random access memory (RAM), a central processing unit (CPU), and a communication control unit, which are connected to each other via a bus, for example. The function and operation of each functional unit described later are implemented by cooperation of the CPU and the memory mounted on the above-described computer and a control program stored in the memory.

The robot control device 1 may include a teaching operation panel (not shown). The teaching operation panel may include a display unit capable of displaying the operation program, such as a monitor, and a touch panel or a keypad via which a teaching command or the like can be input.

As shown in FIG. 2, the robot control device 1 includes an input device 10, a storage device 11, and a processor 17. The storage device 11 and the processor 17 may include a plurality of storage devices 11 and a plurality of processors 17.

The input device 10 receives an input operation made by the operator. The input device 10 may include, for example, the above-described teaching operation panel.

The storage device 11 includes a position information storage unit 12, a time information storage unit 13, a program storage unit 14, an external signal information storage unit 15, and a command storage unit 16.

The position information storage unit 12 stores position information on the robot 2 as the operation path information on the robot 2. Specifically, the position information storage unit 12 stores position information detected at the time of the direct teaching, such as the rotation angle of each servomotor detected.

The time information storage unit 13 stores, as the operation path information on the robot 2, time information when the position information storage unit 12 stores the position information at the time of the direct teaching. That is, the time information storage unit 13 stores the time information in synchronization with the position information stored in the position information storage unit 12. The time information is not limited to an absolute time, and may be not only time-of-day information but also information corresponding to a certain number of control cycles, for example.

More specifically, the position information storage unit 12 and the time information storage unit 13 each store the position information and the time information in any of a case where the robot 2 has moved by a threshold distance (threshold rotation angle) or more, a case where the robot 2 has stopped, and a case where the robot 2 has started moving from a stop state. The above-described threshold distance may be set in advance and be stored in the storage device 11, or the input device 10 may receive an input operation made by the operator and a received arbitrary input value may be stored as the threshold distance in the storage device 11. In the case where the robot 2 has stopped, current position information and time information on the robot 2 are each stored in the position information storage unit 12 and the time information storage unit 13 regardless of the distance by which the robot 2 has moved until then.

Conventionally, depending on an operation to be taught, teaching is to be resumed in some cases after the stop of the robot for a certain time, and in a method of storing the position of the robot in certain sampling cycles, a massive storage capacity is required because teaching data increases with time. It is inconvenient to teach the robot with a teaching range specified every time the robot stops, but according to the present embodiment, no position information and time information are stored while the robot 2 stops, so that the storage capacity can be reduced and a series of operation of the robot 2 including the stop can be continuously taught according to the robot path taught by the direct teaching and the movement speed at the time of teaching.

Moreover, preferably, the position information storage unit 12 and the time information storage unit 13 each store the position information and the time information in any of the case where the robot 2 has moved by a predetermined distance (predetermined rotation angle) or more, the case where the robot 2 has stopped, the case where the robot 2 has started moving from the stop state, and a case where an external signal has changed. The external signal includes, for example, an opening/closing signal for the hand 21 of the robot 2, an operation signal for a touch panel on the teaching operation panel, a signal for pressing down a switch, a signal according to an action such as an action of double-tapping the robot 2 by the operator, and the like.

Further, the position information storage unit 12 and the time information storage unit 13 may store, as a trigger, a change in internal information on the robot 2 itself. That is, the position information storage unit 12 and the time information storage unit 13 may each store the position information and the time information in any of the case where the robot 2 has moved by the threshold distance (threshold rotation angle) or more, the case where the robot 2 has stopped, the case where the robot 2 has started moving from the stop state, the case where the external signal has changed, and a case where the internal information on the robot 2 itself has changed. The internal information on the robot 2 itself includes, for example, a register value of the robot 2 itself and the like.

The program storage unit 14 stores the operation program for the robot 2. The program storage unit 14 stores an operation program generated by a program generation unit 18 of the processor 17 as described later, and stores an operation program input from the outside by the operator or the like.

The external signal information storage unit 15 stores external signal information including a change in the external signal. Specifically, the external signal information storage unit 15 stores, for example, opening/closing information on the hand 21 attached to the robot 2, operation information on the touch panel on the teaching operation panel, information on pressing-down of the switch, a signal according to an action such as an action of double-tapping the robot 2 by the operator, and the like. These pieces of external signal information are stored in the external signal information storage unit 15 in synchronization with the above-described stored position information and time information.

The command storage unit 16 stores a command generated in response to the change in the external signal. For example, the command storage unit 16 stores a command for opening the hand 21 in response to the opening signal for the hand 21, and stores a command for closing the hand 21 in response to the closing signal for the hand 21.

Moreover, the command storage unit 16 stores a command generated in response to the change in the internal information on the robot 2. For example, a command is stored in response to a change in the register value of the robot 2 itself.

As shown in FIG. 2, the processor 17 includes the program generation unit 18 and a program editing unit 19.

The program generation unit 18 generates an operation command including the operation speed of the robot 2 based on the position information and the time information, and generates the operation program for the robot 2 based on the generated operation command. Preferably, the program generation unit 18 generates the operation command including the operation speed of the robot 2 and a stand-by command for the robot 2 based on the position information and the time information, and generates the operation program for the robot 2 based on the generated operation command and stand-by command. Specifically, the program generation unit 18 refers to, as the operation path information on the robot 2, an information group of the position information and the time information stored in synchronization and association with each other in the position information storage unit 12 and the time information storage unit 13, and generates the operation command or the stand-by command according to whether or not there is a before-and-after change in the position information.

In a case where there is the before-and-after change in the position information, i.e., the robot 2 has been operated, the program generation unit 18 calculates the operation speed based on a distance between known teaching points (for example, positions P[1] to P[5] described later) and the time information on each teaching point, and generates the operation command including the position information and the operation speed as parameters. In a case where there is no before-and-after change in the position information, i.e., the robot 2 has stopped, the program generation unit 18 generates the stand-by command including a stop time as a parameter.

Moreover, preferably, the program generation unit 18 generates a command in response to the change in the external signal based on the external signal information stored in the external signal information storage unit 15, and generates the operation program for the robot 2 based on the command generated and stored in the command storage unit 16. For example, the program generation unit 18 generates the operation program for the robot 2 based on the command for opening the hand 21, which is generated in response to the opening signal for the hand 21, which is stored in the external signal information storage unit 15, and is stored in the command storage unit 16. Further, the program generation unit 18 generates the operation program for the robot 2 based on the command for closing the hand 21, which is generated in response to the closing signal for the hand 21, which is stored in the external signal information storage unit 15, and is stored in the command storage unit 16.

Moreover, preferably, the program generation unit 18 generates a command in response to the change in the internal information on the robot 2, and generates the operation program for the robot 2 based on the command generated and stored in the command storage unit 16. For example, the command is generated and stored in response to the change in the register value of the robot 2 itself, and the program generation unit 18 generates the operation program for the robot 2 based on this command.

The program editing unit 19 receives an instruction for editing the operation program for the robot 2, which is stored in the program storage unit 14. With this configuration, the operator can edit, via the input device 10, the operation program for the robot 2, which is stored in the program storage unit 14.

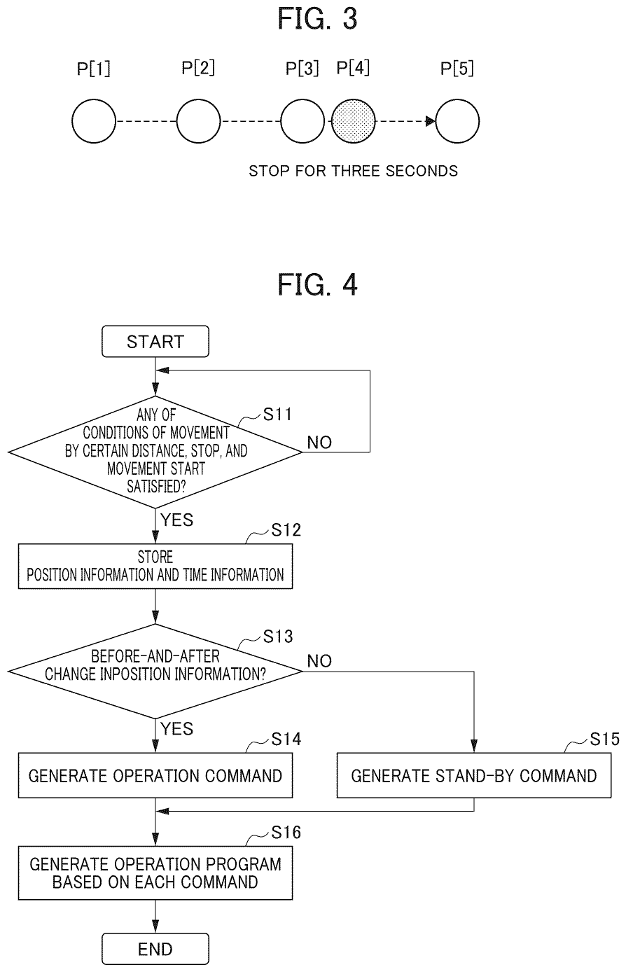

FIG. 3 is a diagram for describing a first example of processing executed by the robot control device 1 according to the present embodiment at the time of the direct teaching. Any of P[1], P[2], P[3], P[4], and P[5] in FIG. 3 indicates the position of the movement destination of the robot 2. As shown in FIG. 3, the first example of the processing of the present embodiment is an operation example where the robot 2 linearly moves from a certain start point (not shown) to the position P[5] after having moved to the position P[4] through the position P[1], the position P[2], and the position P[3] and having stopped for three seconds at the position P[4].

In this first example, when any of a condition where the robot 2 has moved by a certain distance (certain rotation angle) or more, a condition where the robot 2 has stopped, and a condition where the robot 2 has started moving from the stop state is satisfied, the current position information on the robot 2 and the time information at the time of storage of such position information are stored as the operation path information on the robot 2. Then, based on such position information and time information, the operation command and the stand-by command for the robot 2 are generated, and the operation program is generated according to the generated command.

The operation program generated in this first example is, for example, as follows. In the following operation program, any of the position P[1] to the position P[5] satisfies the above-described condition, each position serves as the teaching point, and the position information and the time information are stored for each teaching point.

### Operation Program Example

L P[1] 1000 mm/sec
L P[2] 500 mm/sec
L P[3] 1000 mm/sec
L P[4] 250 mm/sec
WAIT 3.0 [sec]
L P[5] 1000 mm/sec

In the above-described operation program, L indicates the linear movement. Information on each distance between the above-described positions is acquired and grasped by the robot control device 1, and the speed parameter (mm/sec) of the operation command corresponding to each position is set from time-of-day information between the start point and the position P[1], time-of-day information between the position P[1] and the position P[2], time-of-day information between the position P[2] and the position P[3], time-of-day information between the position P[3] and the position P[4], and time-of-day information between the position P[4] and the position P[5]. Moreover, the stand-by time parameter (sec) of the stand-by command is set from time-of-day information until the start of the movement after the stop of the robot 2 at the position P[4].

As described above, in the present embodiment, the operation command or the stand-by command is generated for each position (teaching point) of the position P[1] to the position P[5] for which the position information and the time information are stored. Thus, after the teaching, the parameters such as the position data, the operation speed, and the stand-by time can be easily adjusted and changed.

FIG. 4 is a flowchart showing the steps of the first example of the processing executed by the robot control device 1 according to the present embodiment at the time of the direct teaching. The present processing is repeatedly executed in predetermined control cycles at the time of the direct teaching.

In Step S11, it is determined whether or not any of the condition where the robot 2 has moved by the certain distance (certain rotation angle) or more, the condition where the robot 2 has stopped, and the condition where the robot 2 has started moving from the stop state is satisfied. The processing proceeds to S12 when the answer to this determination is YES, and the determination in Step S11 is repeated when the answer is NO.

In Step S12, the current position information on the robot 2 and the time information synchronized with the position information at the time of storage thereof are stored. That is, in response to any of the condition where the robot 2 has moved by the certain distance (certain rotation angle) or more, the condition where the robot 2 has stopped, and the condition where the robot 2 has started moving from the stop state being satisfied, the current position information and time information on the robot 2 are each stored in the position information storage unit 12 and the time information storage unit 13. Note that in the case where the robot 2 has stopped, the current position information and time information on the robot 2 are each stored in the position information storage unit 12 and the time information storage unit 13 regardless of the distance by which the robot 2 has moved until then. Thereafter, the processing proceeds to Step S13.

In Step S13, it is determined whether or not there is the before-and-after change in the position information.

Specifically, with reference to, as the operation path information on the robot 2, the information group of the position information and the time information stored in synchronization and association with each other in Step S12, it is determined whether or not there is the before-and-after change in the position information. The processing proceeds to Step S14 when the answer to this determination is YES, and proceeds to Step S15 when the answer is NO.

In Step S14, since it is determined in Step S13 that there is the before-and-after change in the position information, the operation speed is calculated from the distance between the positions (teaching points) and the time information, and the operation command is generated. Thereafter, the processing proceeds to Step S16.

In Step S15, since it is determined in Step S13 that there is no before-and-after change in the position information, the stand-by command is generated from the time information on each position (teaching point). Thereafter, the processing proceeds to Step S16.

In Step S16, the operation program for the robot 2 is generated based on the operation command generated in Step S14 or the stand-by command generated in Step S15. Thereafter, the present processing ends.

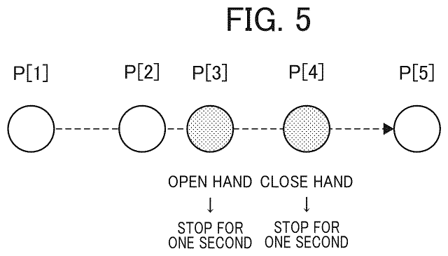

FIG. 5 is a diagram for describing a second example of the processing executed by the robot control device 1 according to the present embodiment at the time of the direct teaching. Similarly to FIG. 3, any of P[1] to P[5] in FIG. 5 indicates the position of the movement destination of the robot 2. As shown in FIG. 5, the second example of the processing of the present embodiment is an operation example where the robot 2 linearly moves from a certain start point (not shown) to the position P[5] through the position P[1], the robot 2 opens the hand 21 and stops for one second at the position P[3], and the robot 2 closes the hand 21 and stops for one second at the position P[4].

In this second example, when any of a condition where the robot 2 has moved by a certain distance (certain rotation angle) or more, a condition where the robot 2 has stopped, a condition where the robot 2 has started moving from the stop state, and a condition where the hand opening/closing signal as the external signal has changed is satisfied, the current position information on the robot 2 and the time information at the time of storage of such position information are stored as the operation path information on the robot 2. Then, based on such position information and time information, the operation command and the stand-by command for the robot 2 are generated, and the operation program is generated according to the generated command.

The operation program generated in this second example is, for example, as follows. In the following operation program, any of the position P[1] to the position P[5] satisfies the above-described condition, each position serves as the teaching point, and the position information and the time information are stored for each teaching point.

### Operation Program Example

L P[1] 1000 mm/sec
L P[2] 500 mm/sec
L P[3] 1000 mm/sec
hand_open
WAIT 1.0 [sec]
L P[4] 250 mm/sec
hand_close
WAIT 1.0 [sec]
L P[5] 1000 mm/sec

Similarly to the above-described first example, in the above-described operation program, L indicates the linear movement, and the speed parameter (mm/sec) of the operation command corresponding to each position is set from the distance information between the positions and the time information. The stand-by time parameter (sec) of the stand-by command is set from time-of-day information until the start of the movement after the stop of the robot 2 at each of the position P[3] and the position P[4]. The command (hand open) for opening the hand 21 is set in response to a change from the closing signal to the opening signal when the hand 21 changes from a closed state to an open state, and the command (hand close) for closing the hand 21 is set in response to a change from the opening signal to the closing signal when the hand 21 changes from the open state to the closed state.

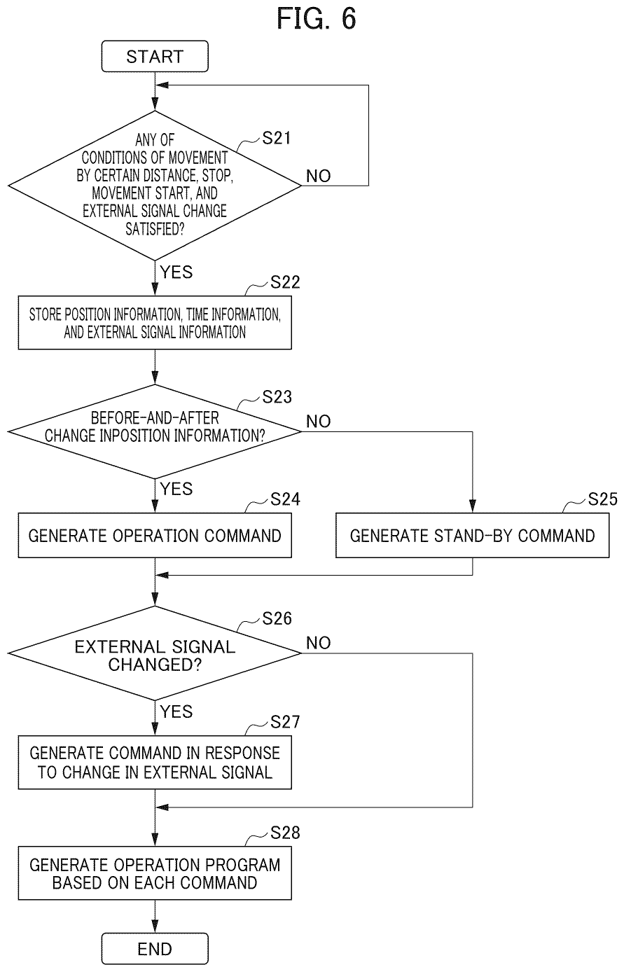

FIG. 6 is a flowchart showing the steps of the second example of the processing executed by the robot control device 1 according to the present embodiment at the time of the direct teaching. The present processing is repeatedly executed in predetermined control cycles at the time of the direct teaching.

In Step S21, it is determined whether or not any of the condition where the robot 2 has moved by the certain distance (certain rotation angle) or more, the condition where the robot 2 has stopped, the condition where the robot 2 has started moving from the stop state, and the condition where the external signal has changed is satisfied. The processing proceeds to S22 when the answer to this determination is YES, and the determination in Step S21 is repeated when the answer is NO.

In Step S22, the current position information on the robot 2, the time information synchronized with the position information at the time of storage thereof, and the external signal information are stored. That is, in response to any of the condition where the robot 2 has moved by the certain distance (certain rotation angle) or more, the condition where the robot 2 has stopped, the condition where the robot 2 has started moving from the stop state, and the condition where the external signal has changed being satisfied, the current position information and time information on the robot 2 are each stored in the position information storage unit 12 and the time information storage unit 13, and the external signal information is stored in the external signal information storage unit 15. Note that in the case where the robot 2 has stopped, the current position information and time information on the robot 2 are each stored in the position information storage unit 12 and the time information storage unit 13 regardless of the distance by which the robot 2 has moved until then. Thereafter, the processing proceeds to Step S23.

Step S23 is similar to Step S13 of FIG. 4, Step S24 is similar to Step S14 of FIG. 4, and Step S25 is similar to Step S15 of FIG. 4.

In Step S26, it is determined whether or not the external signal has been changed. For example, it is determined whether or not the opening/closing signal for the hand 21 as the external signal has changed. The processing proceeds to S27 when the answer to this determination is YES, and proceeds to Step S28 when the answer is NO.

In Step S27, the command is generated in response to the change in the external signal. For example, in response to the change from the closing signal to the opening signal when the hand 21 changes from the closed state to the open state, the command (hand open) for opening the hand 21 is generated. Alternatively, in response to the change from the opening signal to the closing signal when the hand 21 changes from the open state to the closed state, the command (hand close) for closing the hand 21 is generated. Thereafter, the processing proceeds to Step S28.

In Step S28, the operation program for the robot 2 is generated based on the operation command generated in Step S24, the stand-by command generated in Step S25, or the command generated in response to the change in the external signal in Step S27. Thereafter, the present processing ends.

Note that as a third example of the processing executed by the robot control device 1 according to the present embodiment at the time of the direct teaching, the position information and the time information may be stored with the change in the internal information on the robot 2 itself as a trigger. Specifically, a step of determining whether or not the internal information on the robot 2 has changed may be added to the above-described second example, in the case where the internal information has changed, the command may be generated in response to the change in the internal information, and the operation program may be generated based on each generated command.

According to the present embodiment, the following advantages are obtained.

In the present embodiment, the storage device 11 stores the position information on the robot 2, the time information at the time of storage of the position information, and the operation program for the robot 2. Moreover, the processor 17 generates the operation command including the operation speed of the robot 2 based on the position information and the time information, and generates the operation program for the robot 2 based on the generated operation command. With this configuration, based on the position information and the time information stored in synchronization and association with each other, the operation command including the position information and the operation speed as the parameters can be generated, and the stand-by command including the stop time as the parameter can be generated. Thus, according to the present embodiment, the speed at the time of the teaching can be reproduced according to the robot path at the time of the direct teaching. Moreover, since the program is created in units of commands and the operation command includes the position information and the operation speed as the parameters, the position and the operation speed can be easily adjusted and changed after the teaching with reference to the operation command.

In the present embodiment, the processor 17 further generates the stand-by command for the robot 2 based on the position information and the time information, and generates the operation program for the robot 2 based on the generated operation command and stand-by command. With this configuration, based on the position information and the time information stored in synchronization and association with each other, the operation command including the position information and the operation speed as the parameters can be generated, and the stand-by command including the stop time as the parameter can be generated. Thus, according to the present embodiment, a series of operation of the robot 2 including the stop can be continuously taught according to the robot path and speed at the time of the direct teaching. Moreover, since the program is created in units of commands and the operation command includes the position information and the operation speed as the parameters, the position and the operation speed can be easily adjusted and changed after the teaching with reference to the operation command. In addition, since the stand-by command includes the stand-by time as the parameter, the stand-by time can be easily adjusted and changed after the teaching with reference to the stand-by command.

In the present embodiment, the storage device 11 stores the position information and the time information in any of the case where the robot 2 has moved by the threshold distance or more, the case where the robot 2 has stopped, and the case where the robot 2 has started moving. With this configuration, no position information and time information are stored during the stop of the robot 2, and the position information and the time information are stored according to the movement distance of the robot 2. Thus, the storage capacity can be reduced. Conventionally, depending on the operation to be taught, the teaching is to be resumed in some cases after the stop of the robot for the certain time, and in a method of storing the position of the robot 2 in the certain sampling cycles, the massive storage capacity is required because the teaching data increases with time. In addition, it is inconvenient to teach the robot 2 with the teaching range specified every time the robot 2 stops. However, according to the present embodiment, the storage capacity can be reduced, and therefore, a series of operation including the stop can be continuously taught without the teaching range specified. This improves the efficiency of the teaching process.

In the present embodiment, the input device 10 that receives the input operation made by the operator is further provided, and the input value received by the input device 10 is stored as the threshold distance in the storage device 11. With this configuration, the threshold distance taken as the trigger for storing the position information and the time information and used for determining whether or not the robot 2 has moved by the threshold distance or more can be set and changed as necessary by the operator.

In the present embodiment, the storage device 11 stores the position information and the time information in response to the change in the external signal. Moreover, the storage device 11 stores the command generated in response to the change in the external signal, and the processor 17 generates the command in response to the change in the external signal based on the external signal information and generates the operation program for the robot 2 based on the generated command. With this configuration, the operation program can be generated, which includes the command in response to the change in the external signal, such as the command for opening/closing the hand 21, in addition to the operation command and the stand-by command.

In the present embodiment, the storage device 11 stores the position information and the time information in response to the change in the internal information on the robot 2. Moreover, the storage device 11 stores the command generated in response to the change in the internal information, and the processor 17 generates the command in response to the change in the internal information and generates the operation program for the robot 2 based on the generated command. With this configuration, the operation program can be generated, which includes the command in response to the change in the internal information in addition to the operation command, the stand-by command, and the command in response to the change in the internal information.

In the present embodiment, the processor 17 receives the instruction for editing the operation program for the robot 2, which is stored in the storage device 11. With this configuration, the operator can freely edit, for example via the input device 10, the operation program for the robot 2, which is stored in the program storage unit 14.

### Second Embodiment

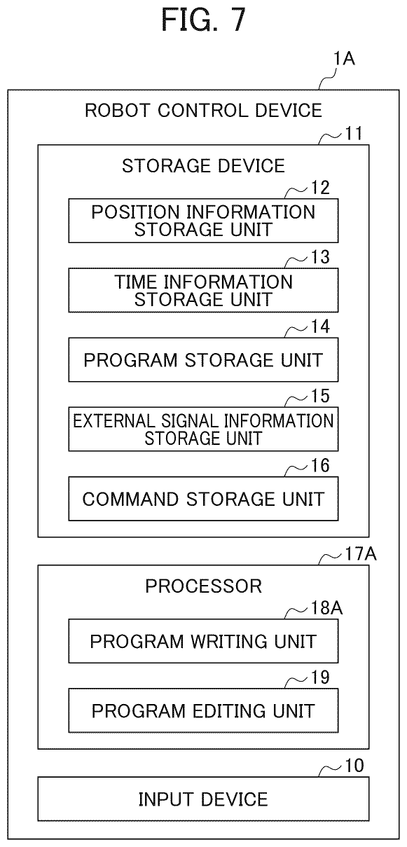

FIG. 7 is a functional block diagram of a robot control device 1A according to the second embodiment. The robot control device 1A according to the present embodiment is different from the robot control device 1 according to the first embodiment in that the program generation unit 18 is replaced with a program writing unit 18A, and other components are similar to those of the first embodiment.

The program writing unit 18A of the present embodiment generates the operation command including the operation speed of the robot 2 based on the above-described position information and time information, and writes the generated command into the operation program stored in the program storage unit 14. Preferably, the program writing unit 18A of the present embodiment generates the operation command including the operation speed of the robot 2 and the stand-by command for the robot 2 based on the above-described position information and time information, and writes the generated operation command and stand-by command into the operation program stored in the program storage unit 14. Moreover, the program writing unit 18A preferably writes, based on the external signal information stored in the external signal information storage unit 15, the command stored in the command storage unit 16 into the operation program stored in the program storage unit 14. Further, the program writing unit 18A may write the command in response to the change in the internal information on the robot 2 into the operation program stored in the program storage unit 14.

Thus, the processing executed by the robot control device 1A according to the present embodiment at the time of the direct teaching is basically similar to that of the first embodiment, except that the operation program is generated in the first embodiment while the command is written into the operation program in the present embodiment. Thus, according to the present embodiment, advantages similar to those of the first embodiment are obtained.

The present disclosure has been described in detail, but is not limited to each of the above-described embodiments.

Various additions, replacements, changes, partial omissions, and the like may be made to these embodiments without departing from the gist of the present disclosure or without departing from the gist of the present disclosure derived from the contents of the claims and the equivalents thereof. These embodiments can also be implemented in combination. For example, in the above-described embodiments, the order of each operation and the order of each type of processing are merely examples and the present disclosure is not limited thereto.

The same also applies to a case where a numerical value or a mathematical expression is used for describing the above-described embodiments.

Regarding the above-described embodiments and modifications, the following additional remarks are further disclosed.

### Additional Remark 1

A robot control device (1) for controlling a robot (2), which includes
at least one storage device (11), and
at least one processor (17),
in which the storage device (11) stores
position information on the robot (2),
time information at the time of storage of the position information, and
an operation program for the robot (2), and the processor (17)
generates an operation command including the operation speed of the robot (2) based on the position information and the time information, and generates the operation program for the robot (2) based on the generated operation command.

### Additional Remark 2

In the robot control device (1),
the processor (17) further generates a stand-by command for the robot (2) based on the position information and the time information, and generates the operation program for the robot (2) based on the generated operation command and stand-by command.

### Additional Remark 3

In the robot control device (1),
the storage device (11) stores the position information and the time information in any of a case where the robot (2) has moved by a threshold distance or more, a case where the robot (2) has stopped, and a case where the robot (2) has started moving.

### Additional Remark 4

The robot control device (1) further includes
an input device (10) that receives an input operation made by an operator, and
the storage device (11) stores an input value received by the input device (10) as the threshold distance.

### Additional Remark 5

In the robot control device (1),
the storage device (11) stores the position information and the time information in response to a change in an external signal.

### Additional Remark 6

In the robot control device (1),
the storage device (11) stores external signal information including the change in the external signal.

### Additional Remark 7

In the robot control device (1),
the storage device (11) stores a command generated in response to the change in the external signal, and
the processor (17) generates a command in response to the change in the external signal based on the external signal information, and generates the operation program for the robot (2) based on the generated command.

### Additional Remark 8

In the robot control device (1),
the storage device (11) stores the position information and the time information in response to a change in internal information on the robot (2).

### Additional Remark 9

In the robot control device (1),
the storage device (11) stores a command generated in response to the change in the internal information on the robot (2), and
the processor (17) generates a command in response to the change in the internal information on the robot (2), and generates the operation program for the robot (2) based on the generated command.

### Additional Remark 10

In the robot control device (1),
the processor (17) receives an instruction for editing the operation program for the robot (2), which is stored in the storage device (11).

### Additional Remark 11

A robot control device (1A) for controlling a robot (2),
which includes
at least one storage device (11), and
at least one processor (17A),
in which the storage device (11) stores
position information on the robot (2),
time information at the time of storage of the position information, and
an operation program for the robot (2), and the processor (17A)
generates an operation command including the operation speed of the robot (2) based on the position information and the time information, and writes the generated operation command into the operation program stored in the storage device (11).

### Additional Remark 12

In the robot control device (1A),
the processor (17A) further generates a stand-by command for the robot (2) based on the position information and the time information, and writes the generated operation command and stand-by command into the operation program stored in the storage device (11).

### Additional Remark 13

In the robot control device (1A),
the storage device (11) stores the position information and the time information in any of a case where the robot (2) has moved by a threshold distance or more, a case where the robot (2) has stopped, and a case where the robot (2) has started moving.

### Additional Remark 14

The robot control device (1A) further includes
an input device (10) that receives an input operation made by an operator, and
the storage device (11) stores an input value received by the input device (10) as the threshold distance.

### Additional Remark 15

In the robot control device (1A),
the storage device (11) stores the position information and the time information in response to a change in an external signal.

### Additional Remark 16

In the robot control device (1A),
the storage device (11) stores external signal information including the change in the external signal.

### Additional Remark 17

In the robot control device (1A),
the storage device (11) stores the command to be written into the operation program in response to the change in the external signal, and
the processor (17A) writes the stored command into the operation program based on the external signal information.

### Additional Remark 18

In the robot control device (1A),
the storage device (11) stores the position information and the time information in response to a change in internal information on the robot (2).

### Additional Remark 19

In the robot control device (1A),
the storage device (11) stores a command generated in response to the change in the internal information on the robot (2), and
the processor (17A) generates a command in response to the change in the internal information on the robot (2), and writes the generated command into the operation program.

### Additional Remark 20

In the robot control device (1A),
the processor (17A) receives an instruction for editing the operation program for the robot (2), which is stored in the storage device (11).

### EXPLANATION OF REFERENCE NUMERALS

1, 1A Robot Control Device
2 Robot
3 Robot System
10 Input Device
11 Storage Device
12 Position Information Storage Unit
13 Time Information Storage Unit
14 Program Storage Unit
15 External Signal Information Storage Unit
16 Command Storage Unit
17, 17A Processor
18 Program Generation Unit
18A Program Writing Unit
19 Program Editing Unit
20 Robot Arm
21 Hand
22 State Detector

1. A robot control device for controlling a robot, comprising:
at least one storage device; and
at least one processor,
wherein the storage device stores
position information on the robot,
time information at a time of storage of the position information, and
an operation program for the robot, and
the processor
generates an operation command including an operation speed of the robot based on the position information and the time information, and generates the operation program for the robot based on the generated operation command.

2. The robot control device according to claim 1, wherein the processor further generates a stand-by command for the robot based on the position information and the time information, and generates the operation program for the robot based on the generated operation command and stand-by command.

3. The robot control device according to claim 1, wherein the storage device stores the position information and the time information in any of a case where the robot has moved by a threshold distance or more, a case where the robot has stopped, and a case where the robot has started moving.

4. The robot control device according to claim 3, further comprising:
an input device that receives an input operation made by an operator,
wherein the storage device stores an input value received by the input device as the threshold distance.

5. The robot control device according to claim 3, wherein the storage device stores the position information and the time information in response to a change in an external signal.

6. The robot control device according to claim 5, wherein the storage device stores external signal information including the change in the external signal.

7. The robot control device according to claim 6, wherein
the storage device stores a command generated in response to the change in the external signal, and
the processor generates a command in response to the change in the external signal based on the external signal information, and generates the operation program for the robot based on the generated command.

8. The robot control device according to claim 3, wherein the storage device stores the position information and the time information in response to a change in internal information on the robot.

9. The robot control device according to claim 8, wherein
the storage device stores a command generated in response to the change in the internal information on the robot, and
the processor generates a command in response to the change in the internal information on the robot, and generates the operation program for the robot based on the generated command.

10. The robot control device according to claim 1, wherein the processor receives an instruction for editing the operation program for the robot, which is stored in the storage device.

11. A robot control device for controlling a robot, comprising:
at least one storage device; and
at least one processor,
wherein the storage device stores
position information on the robot,
time information at a time of storage of the position information, and
an operation program for the robot, and
the processor
generates an operation command including an operation speed of the robot based on the position information and the time information, and writes the generated operation command into the operation program stored in the storage device.

12. The robot control device according to claim 11, wherein the processor further generates a stand-by command for the robot based on the position information and the time information, and writes the generated operation command and stand-by command into the operation program stored in the storage device.

13. The robot control device according to claim 11, wherein the storage device stores the position information and the time information in any of a case where the robot has moved by a threshold distance or more, a case where the robot has stopped, and a case where the robot has started moving.

14. The robot control device according to claim 13, further comprising:
an input device that receives an input operation made by an operator,
wherein the storage device stores an input value received by the input device as the threshold distance.

15. The robot control device according to claim 13, wherein the storage device stores the position information and the time information in response to a change in an external signal.

16. The robot control device according to claim 15, the storage device stores external signal information including the change in the external signal.

17. The robot control device according to claim 16, wherein
the storage device stores the command to be written into the operation program in response to the change in the external signal, and
the processor writes the stored command into the operation program based on the external signal information.

18. The robot control device according to claim 13, wherein the storage device stores the position information and the time information in response to a change in internal information on the robot.

19. The robot control device according to claim 18, wherein
the storage device stores a command generated in response to the change in the internal information on the robot, and
the processor generates a command in response to the change in the internal information on the robot, and writes the generated command into the operation program.

20. The robot control device according to claim 11, wherein the processor receives an instruction for editing the operation program for the robot, which is stored in the storage device.
